(19) United States
(12) Patent Application Publication
(10) Pub. No.: US 2011/0136926 A1
(43) Pub. Date: Jun. 9, 2011

(54) Catalysts for Olefin Hydration and Method of Preparation

(76) Inventors: Jianguo Cai, Suzhou (CN); Zheng Zhang, Shanghai (CN)

(21) Appl. No.: 12/962,798

(22) Filed: Dec. 8, 2010

Related U.S. Application Data
(60) Provisional application No. 61/283,702, filed on Dec. 8, 2009.

(51) Int. Cl. B01J 39/00

(52) U.S. Cl. 521/33

(57) ABSTRACT

The present invention is directed to a polystyrene cation exchange resin catalyst for olefin hydration comprises: monomer units of (a) 7.5 to 11.5 wt % at least one polyvinylaromatic monomer and (b) 88.5 to 92.5 wt % at least one monovinylaromatic monomer; (c) 0.75 to 1.20 SO₃H moiety on each aromatic ring of the polymer backbone; and (d) 0.70 to 1.20 halogen on each aromatic ring of the polymer backbone. The present invention also provides a method for preparing the catalyst including the steps of copolymerization, sulfonation, halogenation, and post treatment. Optimization of the copolymer crosslinking degree, sulfonation and halogenation extent enables the catalyst with a balance of catalysis activity and thermal stability.

This application claims the benefit of priority under 35 U.S.C. §119(e) of U.S. Provisional Patent Application No. 61/283,702 filed Dec. 8, 2009.

The present invention is directed to a polystyrene cation exchange resin catalyst for olefin hydration. The invention also provides a method for preparing the olefin hydration catalyst.

The process for olefin hydrations by using strong acid cation exchange resin as catalyst has been generally described in U.S. Pat. Nos. 4,579,984, 4,340,769 and 4,476,333. Complete conversion of various olefins, such as n-butene for example, is not accomplished mainly due to the limited solubility in water. To increase solubility the reaction temperature is often elevated to 140-170° C. However, the use of elevated temperatures directly leads to the loss of SO₃H groups, and as a result, reduces the catalysis activity. The requirement that the olefin hydration catalyst must run at high temperature to meet the production requirement generates significant drawbacks of high energy cost and high percent of ester byproducts. Elevated temperature also accelerates the corrosion of the reactors.

EP 1,479,665A1 discloses a cation exchange resin catalyst with improved thermal stability for olefin hydration reactions. The catalyst is prepared by the process that generally involves, for example: a styrene divinylbenzene (DVB) copolymer—sulfonate—chlorinate—base treat—and acid regenerate. The resin catalysts prepared by the process has good thermal stability. However, higher catalysis activity is still desired.

Chinese patent CN1240447C discloses a thermostable resin prepared by a process of pressurized copolymerization of styrene-DVB, pressurized boil, halogenation and sulfonation of the copolymer. The resin catalysts prepared by the process exhibit better thermal durability and mechanical stability. However, the catalysis activity (conversion rate) is not satisfied. While not being bound by theory, we hypothesize that the low catalysis activity is due to the high crosslinking degree of the copolymer resin, i.e. 25% based upon calculations from the materials used in the copolymerization. High degrees of crosslinking of the catalyst is unfavorable for reactants ability to diffuse to active sites. In addition, halogenation prior to sulfonation as disclosed in the patent makes the sulfonation hard to be carried out due to the strong electron drawing ability of halogen.

There exists a significant need in the art for catalysts with an improved balance of high catalysis activity and thermal stability, which are capable of olefin hydration at low temperatures. In addition to solving other problems in the art, the present invention provides solutions to satisfy the needs of the art.

The present invention is directed to a polystyrene cation exchange resin catalyst for olefin hydration comprises:

monomer units of (a) 7.5 to 11.5 wt % at least one polyvinylaromatic monomer and (b) 88.5 to 92.5 wt % at least one monovinylaromatic monomer;

(c) 0.75 to 1.20 SO₃H moiety on each aromatic ring of the polymer backbone; and

(d) 0.70 to 1.20 halogen on each aromatic ring of the polymer backbone.

The monomers employed in the suspension copolymerization comprise at least one polyvinylaromatic monomer. The polyvinylaromatic monomers include the group consisting of divinylbenzene, mixture of meta-divinylbenzene and para-divinylbenzene, trivinylbenzene, divinyltoluene, divinylxylene, divinylnaphthalene, and their derivatives such as halide substituted, for example chlorodivinylbenzene. These compounds may be used alone or as a mixture of two or more thereof. One example of a mixture of the present invention is a polyvinylaromatic monomer mixture consists of meta- and para-divinylbenzene.

The amount of the polyvinylaromatic monomer (a) used in the suspension copolymerization is within the range of 7.5 to 11.5% or alternatively from 8.0 to 11.0 wt %., in percentage by weight based on the total weight of the monomers. Thus, the crosslinking degree of the copolymer is within 7.5 to 11.5%.

The monomers employed in the suspension copolymerization comprise at least one monovinylaromatic monomer. Examples of the monovinylaromatic monomers include, but not limit to, styrene and (C₁—C₄)alkyl-substituted styrenes such as ethylvinylbenzene, mixture of meta-ethylvinylbenzene and para-ethylvinylbenzene, vinyltoluene, vinylpyridine, and their derivatives such as halide substituted, for example vinylbenzyl chloride and ethylvinylbenzyl chloride. These compounds may be used alone or as a mixture of two or more thereof. Preferred is selected from the mixtures such as the mixture of meta- and para-ethylvinylbenzene and the mixture of styrene, meta- and para-ethylvinylbenzene.

The amount of the monovinylaromatic monomer (b) used in the suspension copolymerization is within the range of 88,5 to 92.5% or alternatively from 89.0 to 92.0 wt %, in percentage by weight based on the total weight of the monomers.

In one embodiment of the present invention the copolymer contains monomers of, in percentage by weight based on the total weight of the monomers, (a) from 7.5wt % to 11.5wt % at least one polyvinylaromatic monomer selected from meta-divinylbenzene, para-divinylbenzene , and the mixture of meta- and para-divinylbenzene; and (b) from 88.5wt % to 92.5wt % at least one monounsaturated vinylaromatic monomer selected from meta-ethylvinylbenzene; para-ethylvinylbenzene; styrene; the mixture of meta- and para-ethylvinylbenzene; and the mixture of styrene, meta- and para-ethylvinylbenzene.

In another embodiment of the present invention the copolymer contains monomers of, in percentage by weight based on the total weight of the monomers, (a) from 8.0 to 11.0 wt % the mixture of meta- and para-divinylbenzene and (b) from 89.0 to 92.0 wt % the mixture of meta- and para-ethylvinylbenzene.

Optionally, the monomer units may contain up to 3%, alternatively up to 1%, by weight based on the total weight of the monomers, copolymerized polar vinyl monomers, such as for example acrylonitrile, methyl methacrylate, methyl acrylate. Of the monomers mentioned herein, the polar vinyl monomer is excluded from category (a) or (b).

The SO₃H moiety in the catalyst ranges from 0.75 to 1.20 on each aromatic ring of the polymer backbone, i. e. about 3.05 to 3.35 mmol/g, based on the total weight of the catalyst. Alternatively it is present in an amount from 0.85 to 1.05 on each aromatic ring of the polymer backbone or about 3.10 to 3.25 mmol/g.

The halogen on the aromatic ring of the polymer backbone includes, for example, chlorine, bromine and iodine. Specifically suitable is chlorine. The chlorine content in the catalyst is within the range of 0.70 to 1.20 on each aromatic ring of the polymer backbone, i.e. about 16.0 to 21.5%, by weight based on the total weight of the catalyst. Preferred chlorine content is from 0,9 to 1.05 on each aromatic ring of the polymer backbone or about 17.5 to 20.0 wt %.

The catalyst of the first aspect of the invention is preferably prepared by the method comprising the steps of:

(1) suspension copolymerizing monomers comprising of (a) 7.5 to 11.5 wt % at least one polyvinylaromatic monomer and (b) 88.5 to 92.5 wt % at least one monovinylaromatic monomer in the presence of water insoluble organic compound as porogen;

(2) sulfonating the copolymer to obtain a cation resin with 0.75 to 1.20 SO₃H moiety on each aromatic ring of the polymer backbone;

(3) halogenating the cation resin to the extent of 0.70 to 1.20 halogen on each aromatic ring of the polymer backbone;

(4) base treating the halogenated resin;

(5) acid treating the base treated resin;

(6) thermally activating the acid treated resin to obtain the catalyst.

In yet another variant, the catalyst in the first aspect of the invention has volume capacity range from 1.05 to1.25 mol/L, weight capacity range from 3.05 to 3.35 mmol/g and moisture holding capacity range from 48 to 58 wt %.

In yet a further variant, the catalyst in the first aspect of the invention has surface area from 20 to 40 m²/g, pore diameter from 15 to 40 nm and pore volume from 0.10 to 0.30 mL/g.

The monomer units employed in the suspension copolymerization of the second aspect of the invention are the same as of the first aspect. The method for preparing the copolymer of the invention is suitable for any of technically acceptable monomer units' content. Preferably, the monomer units of the second aspect of the invention are in the range of 8.0 to 11.0 wt % polyvinylaromatic monomer and 89.0 to 92.0 wt % monovinylaromatic monomer.

The porogen employed in suspension copolymerization is selected from, as disclosed in the art, organic chlorides, such as, for example methylene dichloride, ethylene dichloride, propylene dichloride, chlorobenzene, chlorotoluene; hydrocarbons, such as cyclohexane, methylcyclohexane, ethylcyclohexane, benzene, toluene, xylene, ethylbenzene; and alcohols, such as dodecanol, methyl iso-butyl carbinol and di-iso-butyl carbinol.

The content of SO₃H and halogen moieties controlled in the preparation process is in the same range as described in the first aspect of the invention.

The halogen substitute in the preparation process includes, for example, chlorine, bromine and iodine. Specifically suitable is chlorine.

The porogen which is employed in suspension copolymerization is selected from water insoluble organics, such as, propylene dichloride, chlorobenzene, cyclohexane, methylcyclohexane, ethylcyclohexane, benzene, toluene, xylene, ethylbenzene, methyl iso-butyl carbinol and dodecanol.

Copolymerization reaction is accomplished in accordance with conventional methods, specifically in a continuous aqueous phase solution containing suspension aids (such as dispersants, protective colloids and buffers) followed by mixing with the organic phase solution containing monomers, porogens and initiators. The monomers are copolymerized at elevated temperature, for example at 25 to 120° C. By this operation, the polymer is obtained directly in the form of rounded beads. The size of the beads is controlled by the stirring rate and the proportion of protective colloid to meet the requirement of resin catalyst preparation processes.

The copolymer obtained is then sulfonated by concentrated sulfuric acid, as know in the art. The concentration of sulfuric acid ranges from 85 to 120 wt %; the reaction temperature ranges from 90 to 130° C. and the reaction time typically ranges from 60 to 400 min. After the reaction is completed, it is then quenched with diluent sulfuric acid and water.

While not being bound by theory, we hypothesize that higher amount of sulfuric group onto the aromatic ring means more active groups for catalysis. However, the higher amount of sulfuric group also results in the fewer amount of halogen could be attached onto the aromatic ring due to the steric hindrance effect from the sulfuric group, which is not good for thermal stability. Therefore, the ratio of sulfuric group to aromatic ring is specifically controlled within the range of 0.75 to 1.20, alternatively from 0.85 to 1.05.

The sulfonated copolymer is then halogenated by the steps of: (i) adding a solution of, such as, ethylene dichloride, chlorobenzene or chlorotoluene containing Lewis acids selected from ferric chloride, aluminum chloride and tin chloride, with water containing acids, for example, sulfuric acid, sulfonic acid or benzene-sulfonic acid and pure water; and then (ii) adding a halogen, such as chlorine, to the slurry and at a temperature of from 0 to 60° C., and alternatively from 10 to 45° C. The ratio of halogen to aromatic ring is also specifically controlled within the range of 0.70 to 1.20, preferably from 0.80 to 1.10, to avoid the sulfuric group being substituted by halogen.

The halogenated resin is then treated by base (i.e. NaOH) to remove the leachable halogen from the polymer backbone of the catalyst in a sealed batch reactor. The base concentration is 5 to 30 wt %; the treating temperature is 50 to 150° C., and the treating time is 20 to 40 hours.

The base treated resin is further treated by acid for example H₂SO₄ to obtain the H form of sulfuric groups in an exchanging column with jacket. The acid concentration is 5 to 40 wt %; the treating temperature is 10 to 60° C., and flow rate is 5 to 30 g/min.

Finally, the acid treated resin is thermally activated in a sealed batch reactor to stabilize the functional groups, i.e. sulfuric groups and halogen and clean the pores of the catalyst. The resin is added into a solvent, such as for example, methanol, ethanol, acetone, water. The ratio of resin to solvent is from 3:1 to 1:4, alternatively from 2:1 to 1:2. The temperature is 80 to 180° C., and treatment time is 20 to 100 hours.

The present invention overcomes the drawbacks of thermal stability and/or catalysis activity in the art by providing the catalyst with precisely controlled halogen and sulphonate moieties on the polystyrene copolymer in adjusted crosslinking degree. The selective ranges of DVB, halogen and sulphonate moieties enable a satisfied balance of high catalysis activity at low temperature with good thermal stability. Unexpectedly, under the same reaction conditions, the conversion of butene per pass by using the catalyst in present invention is about 15% higher than the calculations of the catalysts reported by EP 1479665 A1.

### EXAMPLES

The following examples are intended to illustrate the invention and not to limit it except as it is limited in the claims. All ratios, parts and percentages are by weight unless otherwise stated, and all reagents used are of good commercial quality unless otherwise specified. The abbreviations have the following meanings:

DVB—divinylbenzene

EVB—ethylvinylbenzene

MIBC—methyl iso-butyl carbinol

AIBN—azodiisobutyronitrile

TBP—tert-butyl peroxy-2-ethylhexanoate

### Example 1

To a 4-necked 2 liter flask equipped with a mechanical stirrer, condenser, thermometer, heater and thermocouple assembly was added a premixed aqueous phase consisting of 655 g deionized water, 1.82 g dispersant, 1.82 g boric acid, and 1.05 g sodium hydroxide, and a premixed organic phase of 353.8 g styrene, 47.8 g 63% DVB/37% EVB (i.e. styrene 92.5 wt %, DVB 7.5 wt %), 210 g MIBC, and 3.25 g TBP was then added into the flask. Agitation was started, and the stirring rate was set at 185 rpm, and the mixture was heated to 85 to 95° C. and held at the temperature for 500 min, and the temperature was further enhanced to 98° C. and held at the temperature for 120 min. After the reaction was completed, it was then quenched and the copolymer was separated from the mother liquor and dried at 105 to 135° C. for 6 to 12 hours.

100 g copolymer prepared above; 650 g 93-98 wt % sulfuric acid; and 26.2 g ethylene dichloride were charged to a 4-necked 1 liter flask equipped with a mechanical stirrer, condenser, thermometer, heater and thermocouple and was heated to a temperature of 100 to 130° C. and held there for 100 to 300 min while stirring. The mixture was then cooled to about 60° C. and quenched with sulfuric acid and water according to the following profile:

(i) 420 mL 40 to 65% sulfuric acid was pumped to the flask at a rate of 17 mL/min while stirring; siphoned mother liquor from the flask until the liquid just covered the top of the product;

(ii) 540 mL 20 to 45% sulfuric acid was then pumped to the flask at a rate of 19 mL/min while stirring; siphoned mother liquor from the flask until the liquid just covered the top of the product; and

(iii) 550 mL deionized water was finally pumped to the flask at a rate of 18 mL/min while stirring; separated the product, i.e. cation resin from the mother liquor.

200 g cation resin prepared above and 200 g deionized water were charged to a 4-necked 1 liter flask equipped with a mechanical stirrer, thermometer, gas inlet, heater and thermocouple and was heated to a temperature of 35 to 50° C. 400 g chlorine was introduced to the stirred slurry through the gas inlet tube over 8 to 12 hours. After the reaction was completed, the mother liquor was removed and the resultant product, i.e. chlorinated resin was further washed by deionized water in a column at a rate of 25 mL/min for 200 min. The chlorinated resin contains 21.4% chlorine as determined by a standard elemental chlorine analysis procedure.

200 g chlorinated resin obtained above and 300 g 15 to 20% sodium hydroxide solution were charged to a 4-necked 1 liter flask equipped with a mechanical stirrer, condenser, thermometer, heater and thermocouple and was heated to a temperature of 100 to 130° C. and held there for 20 to 30 h while stirring. The base treated resin was then separated from the mother liquor. The said base treated resin was then transfer to an exchanging column and was firstly treated by deionized water at a down flow rate of 33 mL/min for 120 min and secondly treated by 7% to 14% sulfuric acid at a down flow rate of 15 mL/min for 200 min and thirdly treated by deionized water at a down flow rate of 30 mL/min for 60 min.

Transferred all the resin treated by base and acid above and 300 g deionized water to a 2 liter kettle equipped with a stirrer, heater and thermocouple and was heated to 155 to 185° C. and held there for 40 to 60 hours. The resultant catalyst has volume capacity 1.05 mol/L, weight capacity 3.35 mmol/g, moisture holding capacity 57.8 wt %, chlorine content 21.5 wt %, surface are 20.3 m²/g, pore diameter 39.5 nm, and pore volume 0.30 mL/g.

### Example 2

The procedure of Example 1 was repeated except that 355.6 g styrene, 46.2 g 63% DVB/37% EVB (i.e. styrene 88.5 wt %, DVB 11.5 wt %), 189 g MIBC, and 2.02 g AIBN was added into the flask. Agitation was started, and the stirring rate was set at 180 rpm, and the mixture was heated to 65 to 85° C. and held at the temperature for 300 min, and the temperature was further enhanced to 90 to 100° C. and held at the temperature for 90 min. The resultant catalyst has volume capacity 1.18 mol/L, weight capacity 3.05 mmol/g, moisture holding capacity 48.2 wt %, chlorine content 16.0 wt %, surface are 39.5 m²/g, pore diameter 15.1 nm, and pore volume 0.10 mL/g.

### Example 3

The procedure of Example 1 was repeated except that 335.1 g styrene, 67.0 g 63% DVB/37% EVB (i.e. styrene 89.5 wt %, DVB 10.5 wt %), 189 g MIBC, and 2.02 g AIBN was added into the flask. The resultant catalyst has volume capacity 1.25 mol/L, weight capacity 3.25 mmol/g, moisture holding capacity 55.2 wt %, chlorine content 19.3 wt %, surface are 32.9 m²/g, pore diameter 24.2 nm, and pore volume 0.18 mL/g.

### Example 4

A comparison of catalysis activity was made between the catalysts of Example 1, 2, 3 and together with the two catalysts reported by EP 1479665 A1 (i.e. styrene 93 wt %, DVB 7 wt % (I), and styrene 88 wt %, DVB 12 wt % (II), respectively). The testing conditions are as follows:

Fix bed reactor with the ratio of height to diameter 4:1; Bed volume 14 mL; Reaction temperature 145° C.; Reaction pressure 6.5 MPa; Molar ratio of water to butene 1.8; Flow rate of butane 0.41 mL/min; Flow rate of water 0.14 mL/min.

The results are shown in Table 1.

TABLE 1

| Resin | Butene Conversion per Circle, % | Selectivity to SBA, % |
|---|---|---|
| Example 1 | 5.15 | 99.8 |
| Example 2 | 5.23 | 99.7 |
| Example 3 | 5.46 | 99.8 |
| I | 4.04 | 99.7 |
| II | 4.21 | 99.4 |

### Example 5

Five samples of cation resin prepared as in Example 3 were chlorinated to get different chlorine contents, and the following operations were same as mentioned in Example 3. The testing results thermal stability and catalysis activity of these five catalysts were shown in Table 2 and Table 3, respectively. The testing of catalysis activity is same with what mentioned in Example 5.

TABLE 2

| | Ratio of | | | | | | |
|---|---|---|---|---|---|---|---|
| | chlorine | Before testing | | Testing at 200° C. for 24 h | | | |
| | to | Volume | Weight | Volume | Volume | Weight | Weight |
| | aromatic | Capacity, | Capacity, | Capacity, | Capacity | Capacity, | Capacity |
| Resin | ring | mol/L | mol/Kg | mol/L | Loss, % | mol/Kg | Loss, % |
| A | 0.66 | 1.30 | 3.43 | 0.99 | 24.16 | 2.62 | 23.52 |
| B | 0.71 | 1.25 | 3.34 | 1.03 | 17.23 | 2.82 | 15.47 |
| C | 0.98 | 1.18 | 3.18 | 1.00 | 15.10 | 2.71 | 14.89 |
| D | 1.20 | 1.05 | 3.06 | 0.89 | 14.87 | 2.64 | 13.84 |
| E | 1.24 | 1.01 | 2.99 | 0.87 | 13.68 | 2.59 | 13.49 |

TABLE 3

| Resin | Butene Conversion per Circle, % | Selectivity to SBA, % |
|---|---|---|
| A | 3.95 | 99.8 |
| B | 5.39 | 99.6 |
| C | 5.65 | 99.7 |
| D | 5.44 | 99.7 |
| E | 4.35 | 99.7 |

We claim:

1. A polystyrene cation exchange resin catalyst for olefin hydration comprises:
monomer units of (a) 7.5 to 11.5 wt % at least one polyvinylaromatic monomer and (b) 88.5 to 92.5 wt % at least one monovinylaromatic monomer;
(c) 0.75 to 1.20 SO₃H moiety on each aromatic ring of the polymer backbone; and
(d) 0.70 to 1.20 halogen on each aromatic ring of the polymer backbone.

2. The catalyst according to claim 1, wherein the catalyst comprises:
monomer units of (a) from 8.0 to 11.0 wt % the mixture of meta- and para-divinylbenzene and (b) from 89.0 to 92.0 wt % the mixture of meta- and para-ethylvinylbenzene;
(c) 0.85 to 1.05 SO₃H moiety on each aromatic ring of the polymer backbone; and
(d) 0.90 to 1.05 halogen on each aromatic ring of the polymer backbone.

3. The catalyst according to claim 1, wherein the halogen is chlorine.

4. The catalyst according to claim 1, wherein the catalyst is prepared by the method comprising the steps of:
(1) suspension copolymerizing monomers comprising of (a) 7.5 to 11.5 wt % at least one polyvinylaromatic monomer and (b) 88.5 to 92.5 wt % at least one monovinylaromatic monomer in the presence of water insoluble organic compound as porogen;
(2) sulfonating the copolymer to obtain a cation resin with 0.75 to 1.20 SO₃H moiety on each aromatic ring of the polymer backbone;
(3) halogenating the cation resin to the extent of 0.70 to 1.20 halogen on each aromatic ring of the polymer backbone;
(4) base treating the halogenated resin;
(5) acid treating the base treated resin;
(6) thermally activating the acid treated resin to obtain the catalyst.

5. A method for preparing a polystyrene cation exchange resin catalyst for olefin hydration comprises the steps of:
(1) suspension copolymerizing monomers comprising of (a) 7.5 to 11.5 wt % at least one polyvinylaromatic monomer and (b) 88.5 to 92.5 wt % at least one monovinylaromatic monomer in the presence of water insoluble organic compound as porogen;
(2) sulfonating the copolymer to obtain a cation resin with 0.75 to 1.20 SO₃H moiety on each aromatic ring of the polymer backbone;
(3) halogenating the cation resin to the extent of 0.70 to 1.20 halogen on each aromatic ring of the polymer backbone;
(4) base treating the halogenated resin;
(5) acid treating the base treated resin;
(6) thermally activating the acid treated resin to obtain the catalyst.

6. The method according to claim 6, wherein the halogen is chlorine.

7. The method according to claim 6, wherein the monomer units comprise, in percentage by weight based on the total weight of the monomers, (a) from 8.0 to 11.0 wt % the mixture of meta- and para-divinylbenzene and (b) from 89.0 to 92.0 wt % the mixture of meta- and para-ethylvinylbenzene.

8. The method according to claim 6, wherein the content of SO₃H moiety controlled in the step (2) is in the range of 0.85 to 1.05 per aromatic ring of the polymer backbone.

9. The method according to claim 6, wherein the content of chlorine controlled in the step (3) is in the range of 0.90 to 1.05 per aromatic ring of the polymer backbone.
